(19) United States
(12) Patent Application Publication
(10) Pub. No.: US 2024/0428152 A1
(43) Pub. Date: Dec. 26, 2024

(54) ISSUE ASSIGNMENT WITH HOP FEEDBACK

(71) Applicant: INTERNATIONAL BUSINESS MACHINES CORPORATION, ARMONK, NY (US)

(72) Inventors: John S. Werner, Fishkill, NY (US); Rafaela Frota, Poughkeepsie, NY (US); Faezeh Gholami, Ridgewood, NJ (US); Andrew C. M. Hicks, Highland, NY (US)

(21) Appl. No.: 18/338,069

(22) Filed: Jun. 20, 2023

(51) Int. Cl. G06Q 10/0631

(52) U.S. Cl. CPC G06Q 10/063116

(57) ABSTRACT

Systems and methods are provided for assigning an issue for resolution using natural language processing (NLP) and updating recognition scores for individual/teams accurately redirecting an issue to a different individual/team having a greater ability to resolve it. An issue is analyzed using NLP, and the text is compared to each individual/team's corpus of issues to derive a match percentage. A list is built which ranks individuals/teams by the match percentage. Weights are applied to each individual/team in the list, based on their corresponding recognition scores in their profiles in a profile database. The recognition scores indicate an ability to recognize correct reassignment with a degree of accuracy above a threshold. The list is reordered based on the applied weights, and the issue is assigned to the individual/team having a highest rank.

### BACKGROUND

This invention relates generally to computer systems, and more particularly to issue assignment with hop feedback.

Large scale organizations can have many teams simultaneously working on problems, issues, and ticket resolution. The problem tickets can be reported through Apps, websites, phone, or directly from clients. It may be the case that different teams are unknowingly working on similar problems but are unaware of each other's path towards a solution. This overlap of effort represents an unwanted duplication of effort. Additionally, when a large influx of reported issues occurs, it can be difficult to identify proper allocation of responsibility and team resources, especially if the issues are unfamiliar. Although Natural Language Processing (NLP) is typically used in today's issue resolution routing systems, these systems are not always reliable in routing to the correct individual/team on the first attempt. Clients who are not technically proficient sometimes report issues that do not include the proper terminology or diagnostic data, which can result in the issue being incorrectly directed to the wrong team, thus delaying resolution. Indeed, an issue may be reassigned multiple times and to multiple people/teams before reaching the correct one that can actually work and solve the issue.

It would be advantageous to provide a system to efficiently assign client issues for resolution thereby optimizing both issue resolution and team resources.

### SUMMARY

A method is provided for assigning an issue for resolution using natural language processing (NLP) and updating recognition scores for individual/teams accurately redirecting an issue to a different individual/team having a greater ability to resolve it. An issue is analyzed using NLP, and the text is compared to each individual/team's corpus of issues to derive a match percentage. A list is built which ranks teams/individuals by the match percentage. Weights are applied to each individual/team in the list, based on their corresponding recognition scores in their profiles in a profile database. The recognition scores indicate an ability to recognize correct reassignment with a degree of accuracy above a threshold. The list is reordered based on the applied weights, and the issue is assigned to the individual/team having a highest rank.

### BRIEF DESCRIPTION OF THE SEVERAL VIEWS OF THE DRAWINGS

Embodiments are further directed to computer systems and computer program products having substantially the same features as the above-described computer-implemented method.

FIG. 1 illustrates the operating environment of a computer server embodying a system for analyzing and efficiently routing/rerouting incoming issues;

FIG. 2 illustrates a network diagram for a system for analyzing and efficiently routing/rerouting incoming issues;

FIG. 3 illustrates a flow chart for analyzing a review chain after issue resolution to update recognition scores;

FIG. 4 illustrates a flow chart for directing an issue based on applying weights to an NLP generated review chain based on recognition scores; and

FIG. 5 is an example of profiles in a profile database as updated by the individual/team rerouting module after analysis of a review chain.

### DETAILED DESCRIPTION OF THE INVENTION

Large scale organizations can have many teams simultaneously working on problems, issues, and ticket resolution. It may be the case that different teams are unknowingly working on similar problems but are unaware of each other's path towards a solution. This overlap represents an unwanted duplication of effort. Additionally, when a large influx of reported issues occurs, it can be difficult to identify proper allocation of responsibility and team resources, especially if the issues are unfamiliar or the issues overlap two or more technical areas. Although Natural Language Processing (NLP) is typically used in today's issue resolution routing systems, the reliability of these systems relies on the accuracy of the models on which they are trained and are therefore not always perfect in routing to the correct individual/team on the first attempt. Clients who are not technically proficient sometimes report issues that do not include the proper terminology or diagnostic data, which can result in the issue being incorrectly directed to the wrong team, thus delaying resolution. Indeed, an issue may be reassigned multiple times and to multiple people/teams before reaching the correct one that can actually work and solve the issue. The result is delay of unpredictable length in issue resolution, which likely would increase client dissatisfaction with the offending product, as well as wasting team resources.

Embodiments of the present invention can at least increase a product's Net Promoter Score (NPS), which is a measure of customer loyalty, satisfaction, and enthusiasm with a company. The higher the NPS, the more likely a brand turns customers into advocates. A corollary result is the improvement of team resource allocation and a reduction in wasted time.

Although presented in terms of technical problem resolution, embodiments of the present invention can be implemented generally for applications where customers interact with customer service, such as order entry, and physicians' appointment scheduling.

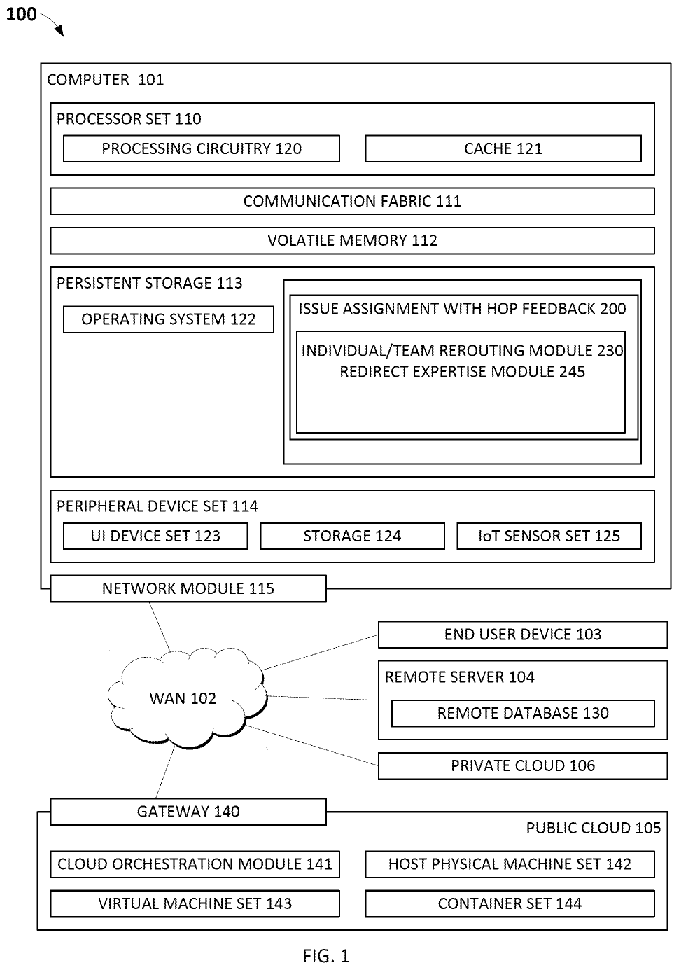

Beginning now with FIG. 1, an illustration is presented of the operating environment of a networked computer, according to an embodiment of the present invention.

Computing environment 100 contains an example of an environment for the execution of at least some of the computer code involved in performing the inventive methods, such as a system for issue assignment with hop feedback 200 (system), embodied in the individual/team rerouting module 230 and the redirect expertise module 245. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, an administrator that operates computer 101), and may take any of the forms discussed above in connection with computer 101. For example, EUD 103 can be the external application by which an end user connects to the control node through WAN 102. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

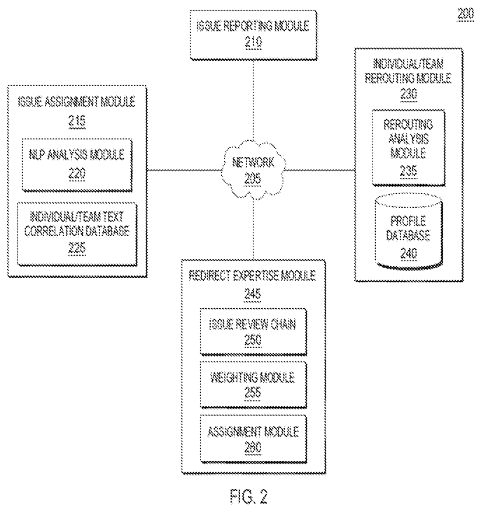

FIG. 2 shows a network diagram 200 for a system that analyzes incoming issues and considers historical information about rerouting of an issue by individuals/teams to weight an NLP generated review chain and, in instances where a threshold recognition score is exceeded, allow manual rerouting.

The network 200 includes the issue reporting module 210, the issue assignment module 215, the individual/team rerouting module 230, and the redirect expertise module 245 all of which are interconnected via wired and/or wireless network 205. Although the system components are shown separately, they may be co-located within a single container, program, application, or server, or may be distributed across a cloud implementation.

The wired and/or wireless network 205 may be any communication protocol that allows data to be transferred between components of the system (e.g., PCIe, I2C, Bluetooth, Wi-Fi, Cellular (e.g., 3G, 4G, 5G), Ethernet, fiber optics, etc.).

The issue reporting module 210 receives problem tickets (issues) from clients regarding one or more products/services. The problem tickets may be routed to the system 200 from an enterprise's problem reporting system, or clients may directly input the problem tickets into the system 200. The fields in the problem ticket may be tailored based on the requirements of the implementation, and may include at least the issue description, name/identifier of the product/application, the issue severity, an initial problem resolution queue, and contact information of the client.

The issue assignment module 215 receives the issue from the issue reporting module 210, and analyzes the data entered for the issue. The issue assignment module 215 produces an ordered list of the individuals/teams that are recommended to be most likely to resolve the issue. As the issue is being worked on, the assigned individual/team can update the issue, for example with additional resolution details, and may return the issue to the issue assignment module 215 which will generate a new list using NLP analysis module 220 using the updated information.

The NLP analysis module 220 invokes one or more Natural language processing (NLP) APIs, such as IBM Watson® NLP to analyze the data entered for an issue (IBM Watson is a registered trademark of IBM in the United States). This entered data is compared to each individual/team's corpus of problem tickets, the output of which is a match percentage for each individual/team. The redirect expertise module 245 receives the output match percentage result from the NLP analysis module 220. The problem ticket is routed to the team with the highest match percentage for the particular issue in the problem ticket.

The individual/team text correlation database 225 is input to the NLP analysis module 220 and includes the corpus of text that correlates previously solved issues to each individual/team.

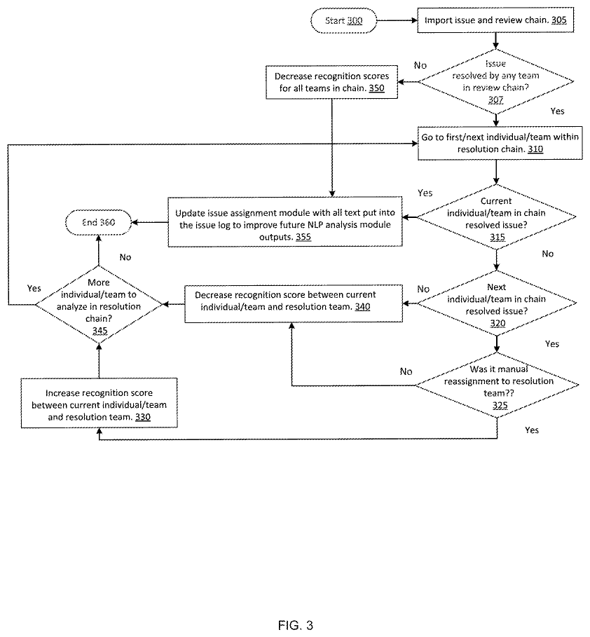

The individual/team rerouting module 230 is comprised of the rerouting analysis module 235 and a profile database 240, which is described further with reference to FIG. 3.

The rerouting analysis module 235 analyzes a full review chain after an issue is resolved and determines the success percentage of an individual/team in recognizing and reassigning a problem to another team. For example, a first team may have a 92% success rate at identifying issues that can be resolved by a second team, but only a 33% success rate at recognizing problems that can be resolved by a third team.

The results of the rerouting analysis module 235 for each individual/team are stored in the profile database 240, which is accessible by the redirect expertise module 245.

Note that in some instances, an issue may be assigned to a specific individual but in other instances, it may be sent to a team where one or more members of that team may work the issue. Embodiments may include profiles being created/updated based on the one or more specific individuals that reviewed/worked the issue or, in alternate embodiments, the team as a whole may have a single profile.

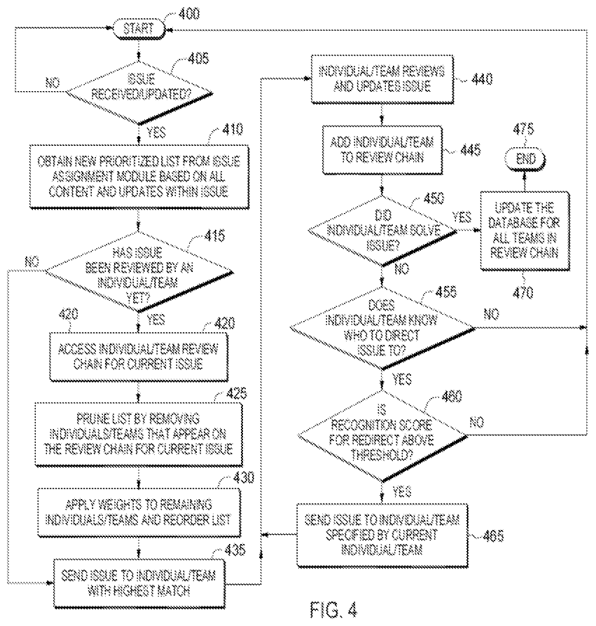

The redirect expertise module 245 (discussed further with reference to FIG. 4) includes the issue review chain 250, the weighting module 255, and the assignment module 260. The redirect expertise module 245 invokes the issue assignment module 215 in conjunction with the profile database 240 to determine possible assignment to second individuals/teams selected from those that have not yet reviewed the current issue. Historical data about an individual's/team's success in rerouting an issue is used to reassign the issue.

The issue review chain 250 is an ordered list created for each issue that contains all the individuals/teams that have reviewed the issue from its initial creation up until its resolution. Not all individuals/teams that appeared on the list generated by issue assignment module 215 and potentially reordered by redirect expertise module 245 will be in the issue review chain. The issue review chain 250 only includes individuals/teams that were assigned to the issue at some point during its resolution.

The weighting module 255 applies weight factors to the list received from the issue assignment module 215 to reorder the list. Information is used in the profiles of the teams currently included in the issue review chain 250 within profile database 240 of individual/team rerouting module 230, which applies weights based on individual/team/s historical information and reorders the NLP generated list from issue assignment module 215. The issue review chain 250 is a chain built of teams to which the issue was assigned at some point because the system 200 evaluated the teams and the issue and estimated that a team on the issue review chain 250 was the best to resolve the issue at that time during the issue resolution process.

For example, the original issue is analyzed, and an ordered list is produced (person A, person B, person C, person D, person E). The issue is assigned to person A who investigates the issue and realizes that the issue should be reassigned. Person A updates the issue and resubmits the issue to the issue assignment module 215. Historical information shows that person A has a 90% success rate of recognizing issues that are solved by person B. The issue with updates from person A is analyzed and another ordered list is produced (person B, person D, person C, person F, person E).

Because person A has historically recognized issues that can be solved by person B above a configurable threshold percentage of success, the list can be updated by down-weighing person B using weighting module 255. After applying weighting, the list is reordered as such (person D, person C, person F, Person E, person B) and the issue can then be routed to person D.

Where implementations of the present invention are not present, the issue may have likely taken longer to resolve by first routing the issue to person B who was next in line in the original list. The assignment module 260 may then assign the issue to the individual/team that is at the top of the reordered list after applying weight factors.

FIG. 3 shows a method 300 which initiates its execution via individual/team rerouting module 230. The rerouting analysis module 235 component of the individual/team rerouting module 230 analyzes an issue review chain 250 once an issue has been resolved and adjusts a recognition score within a profile which is utilized by weighting module 255 to apply weight factors to each individual/team in an NLP generated list based on whether the individual/team correctly identified and/or manually rerouted the issue to the individual/team that solved said issue.

If an individual/team identifies a path of resolution (one manual hop to the individual/team that resolved the issue), that individual/team is weighted higher and positively reinforced (increased recognition score) for recognition of issues belonging to the other individual/team.

If an individual/team incorrectly routes an issue to another individual/team or does not recognize where an issue should go and provides no manual redirect input, that individual/team is down weighted and negatively reinforced (decreased recognition score) for recognition of issues belonging to the individual/team that eventually resolved the issue.

The method 300 begins at block 305 which represents the initial import of an issue and its associated issue review chain 250. The issue review chain 250 is an ordered list of individuals/teams that reviewed the issue.

The individual/team rerouting module 230 then moves to decision block 307 to determine if the issue was resolved.

If the issue was resolved (block 307 “Yes” branch), the individual/team rerouting module 230 proceeds to block 310 to begin/continue an iteration loop that analyzes each individual/team within the issue review chain 250.

The individual/team rerouting module 230 determines (at 315) if the current individual/team being analyzed within the issue review chain 250 resolved the issue. At this point in the flowchart, the last team within the issue review chain 250 will be the one that resolved the issue. If the current individual/team that is being analyzed within the issue review chain 250 did not resolve the issue (block 315 “No” branch), the individual/team rerouting module 230 proceeds to decision block 320 to determine if the next individual/team within the issue review chain 250 resolved the issue (i.e., the current individual/team being analyzed is second to last within the issue review chain 250).

If the next individual/team within the issue review chain 250 did resolve the issue (block 320 “Yes” branch) the individual/team rerouting module 230 moves to decision block 325 to determine if it was a manual reassignment to the individual/team that resolved the issue. An individual/team may manually reroute an issue to another individual/team (at 465 of FIG. 4) based on having a high degree of certainty where the issue belongs.

If the issue was resolved as a result of a manual reassignment to the correct individual/team (block 325 “Yes” branch), the individual/team rerouting module 230 continues to block 330 to increase the recognition score between the current individual/team and the individual/team that resolved the issue.

Recognition scores for each individual team are stored on the profile database 240.

In one or more embodiments, the recognition scores may be a percentage of issues that have passed through a team and that were recognized and correctly rerouted manually. For example, out of ‘14’ issues that Team A reviewed that were eventually resolved by Team D, Team A correctly identified Team D as the team that could resolve the issue ‘7’ times, giving a recognition score of ‘0.5’ or 50%.

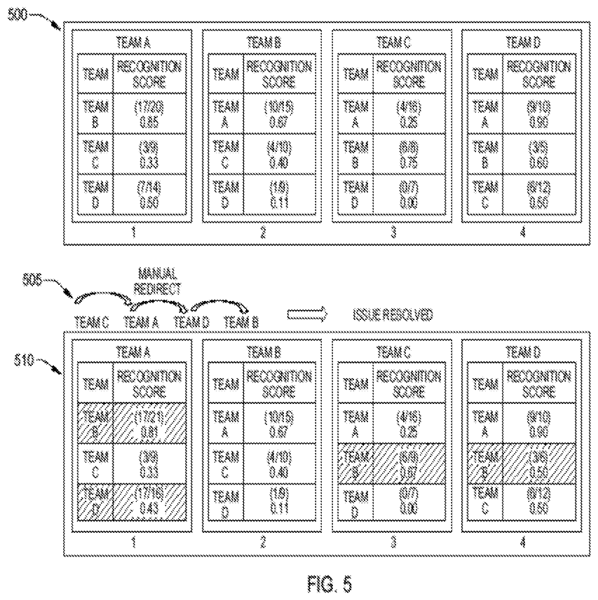

Each individual/team can have many scores. Each score correlates the individual/team's recognition of issues that belong to each of the other individuals/teams, one score per individuals/team. For example, if scores range from ‘0’ to ‘1’, Team A's profile may contain the following recognition scores: recognition of issues belonging to Team B: ‘0.85’, recognition of issues belonging to Team C: ‘0.33’, and recognition of issues belonging to Team D: ‘0.50’. The individual/team relationship is shown in profile 500 and profile 510 of FIG. 5.

If the next individual/team within the issue review chain 250 did not resolve the issue (block 320 “No” branch) or if it was a not a manual reassignment to the individual/team that resolved the issue (block 325 “No” branch), the individual/team rerouting module 230 executes block 340 which will decrease the recognition score between the current individual/team and the individual/team that resolved the issue.

In one or more embodiments, a larger decrease in recognition score may be assigned if block 340 is reached after an incorrect manual reassignment (from 325), compared to the decrease that would be assigned if coming from block 320. For example, if the recognition score is a percentage, an incorrect manual redirect could be counted twice which would decrease the score more than if it were counted once for simply not recognizing where the issue belongs and returning it to the issue assignment module 215. This is shown with reference to FIG. 5 below.

After executing either block 330 or 340, the individual/team rerouting module 230 moves to decision block 345 to determine whether there are more individuals/teams within the issue review chain 250 to analyze.

If there are more individuals/teams to analyze (block 345 “Yes” branch), the individual/team rerouting module 230 loops back to block 310 to analyze the next individual/team.

Returning to block 307, if the issue was not resolved (block 307 “No” branch), the individual/team rerouting module 230 proceeds to block 350 and decreases recognition scores for all individuals/teams within the issue review chain 250. Once again, a larger decrease in recognition score may be assigned if an incorrect manual reassignment occurred within the issue review chain 250.

After executing block 350, or if the current individual/team that is being analyzed within the issue review chain 250 did resolve the issue (block 315 “Yes” branch), the individual/team rerouting module 230 proceeds to block 355 and updates individual/team text correlation database 225 on the issue assignment module 215 with the original text of the issue and all subsequent updates in the issue's log to improve future NLP analysis module 220 outputs.

If there are no more individuals/teams to analyze (block 345 “No” branch), or after executing block 355, the individual/team rerouting module 230 ends at block 360.

FIG. 4 illustrates the operation of the redirect expertise module 245, which is executed to adjust the output of the NLP analysis module 220 to direct an issue to the proper individual/team for faster resolution. The redirect expertise module 245 takes into account historical information about issue rerouting from individuals/teams that have already reviewed the current issue and applies weighting to the output of the issue assignment module 215. The weights are applied based on recognition scores that are determined from an analysis of past issues as discussed in FIG. 3. The intended result is that fewer hops are required to direct the issue to the correct individual/team.

The redirect expertise module 245 begins at decision block 405 to determine whether the received issue is new, or if the issue has been previously reviewed and updated by one or more of the individuals/teams. The issue may be updated with data showing that it was previously incorrectly routed to an individual/team that was unable to solve the issue.

In preferred embodiments, an individual/team that has reviewed the current issue will enter additional information to assist the NLP analysis module 220 in providing a better output list on the next iteration through the redirect expertise module 245.

If a new issue has not been received or if the current issue has not been updated (block 405 “No” branch), the redirect expertise module 245 loops back to the start and waits for new activity.

If a new issue has been received or if a current issue has been updated (block 405 “Yes” branch), the redirect expertise module 245 proceeds to block 410 to obtain a new prioritized list from the issue assignment module 215 based on all content and updates already made to the issue.

The issue assignment module 215 invokes the NLP analysis module 220 to generate a list (e.g., top 3, top 5, etc. of teams in all teams) of individuals/teams that may be able to solve the issue based only on the text that is inserted into the issue.

The redirect expertise module 245 then executes decision block 415 to determine if this is the first pass through the issue assignment module 215.

If the issue has previously been reviewed by one or more individuals/teams (block 415 “Yes” branch), the redirect expertise module 245 continues to block 420 to access the issue review chain 250 for the current issue being analyzed. The issue review chain 250 is a list of the individuals/teams that have already reviewed the current issue, listed in the order the individual/team received it. The issue review chain 250 may be stored in the data associated with the issue as it progresses towards resolution. This data can then be stored in the database 225, which is where the training data for the NLP analysis module is also stored. Alternatively, the data may be stored in a separate database (not shown), that holds all the ticket data, for example, a system-wide problem ticket management system.

At block 425, the redirect expertise module 245 prunes the output list by removing individuals/teams that appear on the issue review chain 250 for the current issue.

Based on the text within the issue, if the text is updated, e.g., revised, or otherwise amended, an individual/team may subsequently appear again on the list from the issue assignment module 215. However, since those individuals/teams have already been unsuccessful in resolving the issue, they can be removed from the list such that the issue is not sent to them a second time.

The redirect expertise module 245 moves to block 430 to apply weights to the remaining individuals/teams and to reorder the list. Weighting is based on the recognition score generated by the individual/team rerouting module 230 and stored within the profile database 240. In one or more embodiments, the recognition score can map linearly to a weighting factor between ‘0.5’ and ‘1.5.’ For example, a recognition score of ‘0.5’ correlates to a weighting factor of ‘1.0’ and a recognition score of ‘0.9’ correlates to a recognition score of ‘1.4.’ This is a linear interpolation of a recognition score between ‘0’ and ‘1’ being mapped to a weighting factor between ‘0.5’ and ‘1.5’.

After executing block 430 or if the issue has not been reviewed by one or more individuals/teams (block 415 “No” branch), the issue assignment module 215 executes block 435 and sends the issue, using assignment module 260, to the individual/team that is at the top of the list.

If entered from block 415 “No” branch, at 435 the individual/team will be the highest match directly from the NLP analysis module 220. If entered from block 430, at 435 the redirect expertise module 245 is using the pruned list that was reordered based on weighting.

At block 440, the individual/team receiving the issue from the redirect expertise module 245 reviews and updates the issue. The redirect expertise module 245 may sit at this block for the current issue for a while as the individual/team performs necessary analysis, testing, etc. The duration of the wait is dependent on the nature of the issue being resolved. Some issues may be resolved in minutes, while others may take days, or longer. The redirect expertise module 245 saves the state of the issue, so that processing can continue at block 440.

The redirect expertise module 245 then proceeds to block 445 to add the current individual/team to the issue review chain 250 for the current issue. The issue review chain 250 may be stored in data associated with the issue, as in a system-wide problem management system, as it progresses towards a solution.

At 450, the redirect expertise module 245 determines whether the current individual/team solved the issue. This determination can be made within the issue system where a team can close the issue, mark the issue complete/solved, etc.

If the current individual/team did not solve the current issue (block 450 “No” branch), the redirect expertise module 245 moves to decision block 455 where the redirect expertise module 245 accepts input from the current individual/team if an alternate individual/team with a higher likelihood of resolving the current issue is suggested. For example, team A may not be able to solve the current issue but believes that team B is the correct team that has the expertise to resolve the issue.

If the current individual/team inputs an alternate individual/team (block 455 “Yes” branch), the redirect expertise module 245 proceeds to decision block 460 to determine if the recognition score between the current individual/team and the suggested alternate individual/team is above a configurable threshold.

For example, if the threshold is set to 75% and team A has a 90% success rate at redirecting issues to team B and that team solves the issue, the “Yes” branch of block 460 will be taken. If team A only has a 30% success rate at redirecting issues to team C where that team was able to solve the issue, the “No” branch of block 460 will be taken.

In preferred embodiments, if an individual/team has little or no history in redirecting to a specific team, the redirect expertise module 245 may accept the suggested alternate individual/team yet still take the “No” branch such that the user profile can build up a recognition score between the two teams. The history can be evaluated based on a configurable threshold count indicating expertise. For example, if a first team has not seen at least five issues that were resolve by a second team, the “No” branch would be taken.

If the recognition score for redirect is above the configurable threshold (block 460 “Yes” branch), the redirect expertise module 245 moves to block 465 and sends the issue to the individual/team specified by current individual/team, then loops back to block 440 to allow the new individual/team to work the issue.

This manual redirect will be stored in the data associated with the issue and taken into account in method 300 for adjusting the recognition score between the two individuals/teams for future issues. The recognition score will increase if the current individual/team is correct with their manual rerouting and will decrease if they are incorrect.

If the current individual/team does not input a suggested alternate individual/team (block 455 “No” branch) or if the recognition score for redirect is below the configurable threshold (block 460 “No” branch) or the count threshold is not met, the redirect expertise module 245 loops back to the start and repeats with the additional data entered into the issue and the updated issue review chain 250.

If the current individual/team did solve the current issue (block 450 “Yes” branch), the redirect expertise module 245 moves to block 470 to update the profile database 225 for all teams in the issue review chain 250 by executing method 300 using the individual/team rerouting module 230. The database 225 is also updated so that the NLP analysis module 220 continues to learn from resolved issues.

After executing block 470, the redirect expertise module 245 ends for the current issue at block 475.

FIG. 5 is an example of a profile database as updated by the individual/team rerouting module 230. Profile example 500 shows four team profiles and their recognition scores for issues that were resolved by other teams. The following issue review chain 250 that was sent to the rerouting analysis module 235 had one manual redirect, that is, from Team A to Team D, as shown in 505 of FIG. 5. Team B eventually resolved the issue. Team C initially received the issue but did not recognize an issue that Team B eventually resolved.

Profile 510 shows the four team profiles following the updating by the individual/team rerouting module 230. All the recognition scores relative to Team B in each of the teams' profiles were changed, based on Team C's and Team D's inability to recognize the issue, and Team A's incorrect manual redirect action to Team D. Even though Team B resolved the issue, Team A incorrectly manually redirected the issue to Team D, resulting in Team A's score towards Team D to be down-weighted twice. To be able to manually redirect, a team must exceed a configurable recognition threshold. Therefore, to ensure the team remains above the recognition threshold, and remains proficient at recognizing issues that belong to another team, the team is penalized for an incorrect manual redirect. This is shown in the profile 510, and in the manual redirect example of 505.

In Profile 500_3 of the example, Team C initially had correctly identified ‘6’ out of ‘8’ issues, or ‘0.75’, that Team B ultimately resolved.

However, Team C was assigned the issue, which the team did not recognize and therefore could neither resolve nor redirect. Profile 510_3 shows how Team C's recognition score toward Team B was down weighted, since Team C now only recognizes ‘6’ out of ‘9’ issues, or ‘0.67’. Team A then received the issue, as shown in 505 of FIG. 5. Team A incorrectly manually rerouted the issue to Team D. As a result, Team A's recognition score toward Team B is down weighted from ‘17’ out of ‘20’ (in profile 500_1) to ‘17’ out of ‘21’ in profile 510_1. However, since Team A manually redirected the issue to the wrong team, Team D. Team A is penalized twice toward Team D for not recognizing the issue and for incorrectly manually redirecting the issue to Team D. As a result, Team A's recognition score toward Team D, initially ‘7’ out of ‘14’, is now ‘7’ out of ‘16’.

As an example of weight factors applied to an NLP generated review chain, assume the NLP analysis generates a score between ‘0’ and ‘1’ when matching an individual/team to an issue. If Team A sees a new issue that it could neither resolve nor manually redirect but returns the issue to the issue assignment module 215, weights can be applied based on the recognition scores in Team A's recognition profile. One way to do this is to multiply the output of the NLP analysis module 220 by ‘1’ minus the recognition scores for each of the teams within Team A's profile. At this point in the processing, Team A is the only team to have seen the issue so far. If Team B had a 90% NLP match to the issue on the second pass of routing and assigning the issue, the resulting weight would be (0.9*(1−0.81)), or 0.171. As a result of the pruning process described above with reference to FIG. 4, this significantly down-weights Team B to a lower position on the list. This is a good result, since history indicates that Team A has a high recognition score toward Team B (‘0.081’ from 510_1). However, since Team A did not manually redirect the issue to Team B, there is a high probability that Team B will be unable to resolve the issue.

As may be used herein, the terms “substantially” and “approximately” provide an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to.” As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with,” includes direct and/or indirect coupling of separate items and/or one item being embedded within another item.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules, and components herein, can be implemented as illustrated or by discrete components, application specific integrated circuits, processors executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from Figure to Figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information. A computer readable memory/storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprising:
performing Natural Language Processing (NLP) analysis of text within an issue, wherein the analyzed text is compared to each of a plurality of individual/team's corpus of issues, the output being a match percentage for each individual/team to the issue;
building a list of individuals/teams ranked by the match percentage;
applying weights to each individual/team in the list, based on their corresponding recognition scores in their profiles in a profile database, and wherein the recognition scores indicate an ability to recognize correct reassignment with a degree of accuracy above a threshold;
reordering the list based on the applied weights; and
assigning the issue to the individual/team having a highest rank.

2. The method of claim 1, wherein the issue is assigned to the individual/team having the highest rank from the NLP analysis with no weight being applied, based on this being a first iteration and based on there being no previous issue review chain.

3. The method of claim 1, wherein the assigned individual/team manually reassigns the issue to another individual/team, based on the recognition score for making reassignments to the other individual/team being above a threshold.

4. The method of claim 1, wherein the recognition score is weighted higher for manually reassigning the issue to another individual/team that resolved the issue.

5. The method of claim 1, wherein the recognition score of the individual/team is weighted lower for manually reassigning the issue to another team that did not resolve the issue.

6. The method of claim 1, wherein the recognition score is weighted lower for returning the issue for reassignment based on the individual/team not resolving the issue and not manually reassigning the issue.

7. The method of claim 1, wherein upon being resolved the issue review chain is analyzed, the analysis comprising: updating the recognition scores of the profiles in the profile database; and updating the text corpus used for NLP analysis.

8. A computer program product, the computer program product comprising a non-transitory tangible storage device having program code embodied therewith, the program code executable by a processor of a computer to perform a method, the method comprising:
performing Natural Language Processing (NLP) analysis of text within an issue, wherein the analyzed text is compared to each of a plurality of individual/team's corpus of issues, the output being a match percentage for each individual/team to the issue;
building a list of each individuals/team ranked by the match percentage;
applying weights to each individual/team in the list, based on their corresponding recognition scores in their profiles in a profile database, and wherein the recognition scores indicate an ability to recognize correct reassignment with a degree of accuracy above a threshold;
reordering the list based on the applied weights; and
assigning the issue to the individual/team having a highest rank.

9. The computer program product of claim 8, wherein the issue is assigned to the individual/team having the highest rank from the NLP analysis with no weight being applied, based on this being a first iteration and based on there being no previous issue review chain.

10. The computer program product of claim 8, wherein the assigned individual/team manually reassigns the issue to another individual/team, based on the recognition score for making reassignments to the other individual/team being above a threshold.

11. The computer program product of claim 8, wherein the recognition score is weighted higher for manually reassigning the issue to another individual/team that resolved the issue.

12. The computer program product of claim 8, wherein the recognition score of the individual/team is weighted lower for manually reassigning the issue to another team that did not resolve the issue.

13. The computer program product of claim 8, wherein the recognition score is weighted lower for returning the issue for reassignment based on the individual/team not resolving the issue and not manually reassigning the issue.

14. The computer program product of claim 8, wherein upon being resolved the issue review chain is analyzed, the analysis comprising: updating the recognition scores of the profiles in the profile database; and updating the text corpus used for NLP analysis.

15. A computer system, comprising:
one or more processors;
a memory coupled to at least one of the processors;
a set of computer program instructions stored in the memory and executed by at least one of the processors in order to perform actions of:
performing Natural Language Processing (NLP) analysis of text within an issue, wherein the analyzed text is compared to each of a plurality of individual/team's corpus of issues, the output being a match percentage for each individual/team to the issue;
building a list of each individuals/team ranked by the match percentage;
applying weights to each individual/team in the list, based on their corresponding recognition scores in their profiles in a profile database, and wherein the recognition scores indicate an ability to recognize correct reassignment with a degree of accuracy above a threshold;
reordering the list based on the applied weights; and
assigning the issue to the individual/team having a highest rank.

16. The computer system of claim 15, wherein the issue is assigned to the individual/team having the highest rank from the NLP analysis with no weight being applied, based on this being a first iteration and based on there being no previous issue review chain.

17. The computer system of claim 15, wherein the assigned individual/team manually reassigns the issue to another individual/team, based on the recognition score for making reassignments to the other individual/team being above a threshold.

18. The computer system of claim 15, wherein the recognition score is weighted higher for manually reassigning the issue to another individual/team that resolved the issue.

19. The computer system of claim 15, wherein the recognition score of the individual/team is weighted lower for manually reassigning the issue to another team that did not resolve the issue.

20. The computer system of claim 15, wherein upon being resolved the issue review chain is analyzed, the analysis comprising: updating the recognition scores of the profiles in the profile database; and updating the text corpus used for NLP analysis.
